(19) United States
(12) Patent Application Publication
(10) Pub. No.: US 2017/0023795 A1
(43) Pub. Date: Jan. 26, 2017

(54) LENS AND FRAME ASSEMBLY STRUCTURE FOR GLASSES

(71) Applicant: PROHERO GROUP CO., LTD., TAINAN CITY (TW)

(72) Inventor: PEN-WEI CHEN, TAINAN CITY (TW)

(21) Appl. No.: 14/806,831

(22) Filed: Jul. 23, 2015

(51) Int. Cl. G02C 1/00; G02C 1/04; G02C 5/02

(52) U.S. Cl. CPC G02C 1/10; G02C 5/02; G02C 1/04

(57) ABSTRACT

This invention is related to a lens and frame assembly structure for glasses. A lens assembly slot for assembling a lens is formed on a frame. Two sliding grooves are corresponded to the two side of the lens assembly slot respectively for assembling the fastening elements. Long slots are formed on the top and bottom surface of each sliding groove respectively for embedding retaining blocks which are formed on the top and bottom surface of each fastening element, thereby allowing each fastening element sliding in each sliding groove without separation. Furthermore, an embedding part projects out from each fastening element toward the lens assembly slot for embedding the embedding part into the recess of the lens. Therefore, the fastening elements on the frame are pushed to assemble or separate the lens and the frame without using any tools.

### BACKGROUND OF THE INVENTION

Field of the Invention

The present invention relates to a lens and frame assembly structure for glasses. More particularly, the disclosure relates to a lens and frame assembly structure for glasses that does not require other tools during assembling or separating the lens and the frame, so it is simpler and more convenient to assemble or separate the lens and the frame.

Description of Related Art

The general glasses are divided into optical glasses, sunglasses, sport spectacles, and safety glasses, according to their uses and function. The frame design of different type of the glasses is different. For example, in the full-rim glasses, the lens is all received in the frame to protect the safety of the lens, so the full-rim glasses are used in optical glasses with expensive lens. However, the half-rim glasses is lighter than the full-rim glasses, so it is used in sunglasses, sports spectacles, and safety glasses, which emphasis in light weight and well-executed, for user doing sport, outside exercise, or construction.

Whatever the glasses is applied for, the basic structure of the glasses comprises the lens assembled with the frame. The lens is assembled with the assembly hole of the frame and fixed in the screw hole in the assembly hole of the frame by the screws, so the lens is held between the assembly holes of the frame. Then, the temples are pivoted with the two sides of the frame to complete the assembly of the glasses.

The lens of the foregoing glasses is fixed between the assembly holes of the frame by screws; however, in the actual use, it requires the tools for assembling the lens with the frame or separating the lens from the assembly holes. It is inconvenient to assemble or separate the lens, if the user does not have the proper tool in hands, it results that the lens cannot be assembled with or separated from the frame.

### SUMMARY OF THE INVENTION

Therefore, the object of the present invention is related to a lens and frame assembly structure for glasses, in which the fastening elements on the frame are pushed to assemble or separate the lens and the frame without using any tools, so it is simpler and more convenient to assemble or separate the lens and the frame.

For the above object, a lens and frame assembly structure for glasses comprises a frame, two fastening elements, and a lens.

The frame comprises a lens assembly slot, two sliding grooves corresponded to the two sides of the lens assembly slot, respectively, and two long slots formed on the top surface and bottom surface of each sliding groove, respectively.

The fastening elements are set in the sliding grooves respectively, and each fastening element comprises two retaining blocks and an embedding part. The retaining blocks are formed on the top surface and bottom surface of each fastening element and corresponded to the long slots on each sliding groove, thereby embedding the retaining blocks into the long slots on each sliding groove to retaining the position of each fastening element and allowing each fastening element sliding in each sliding groove without separation. The embedding part projects out from each fastening element toward the lens assembly slot.

The lens is assembled with the lens assembly slot of the frame and formed with two recesses corresponded to the embedding part of each fastening element for embedding the embedding part into the recess.

### BRIEF DESCRIPTION OF THE DRAWINGS

FIG. 1 is a front exploded view of a lens and frame assembly structure for glasses according to an embodiment of the present invention;

FIG. 2 is a back exploded view of a lens and frame assembly structure for glasses according to an embodiment of the present invention;

FIG. 3 is a side view of a lens and frame assembly structure for glasses during an assembly process according to an embodiment of the present invention;

FIG. 4 is a top partial-sectional view of a lens and frame assembly structure for glasses during an assembly process according to an embodiment of the present invention;

FIG. 5 is a side view of a lens and frame assembly structure for glasses when used according to an embodiment of the present invention;

FIG. 6 is a top partial-sectional view of a lens and frame assembly structure for glasses when used according to an embodiment of the present invention;

FIG. 7 is a three-dimensional view of a lens and frame assembly structure for glasses according to an embodiment of the present invention; and

FIG. 8 is a top sectional view of a lens and frame assembly structure for glasses according to an embodiment of the present invention.

### DETAILED DESCRIPTION OF THE PREFERRED EMBODIMENT

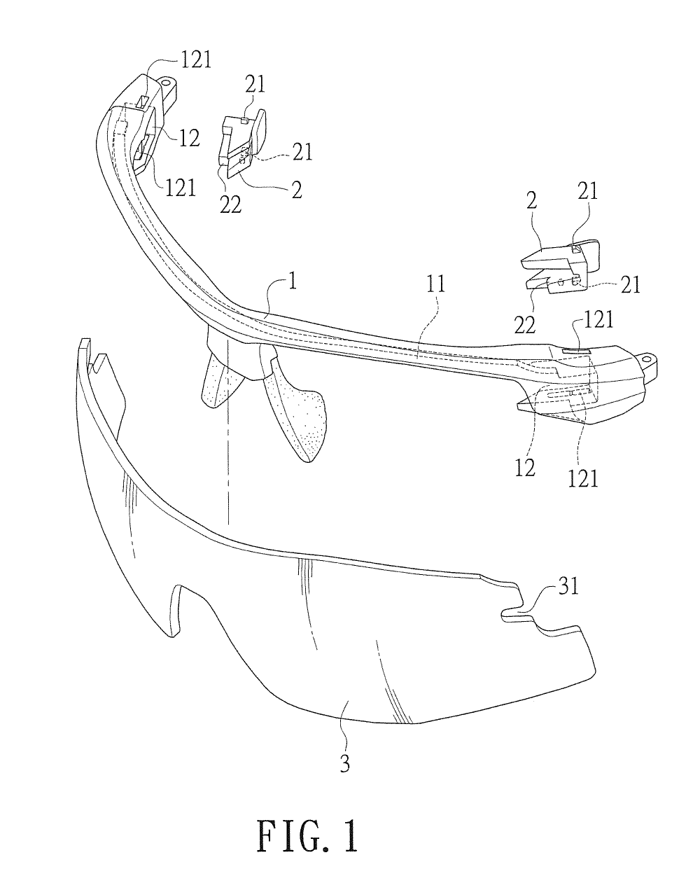

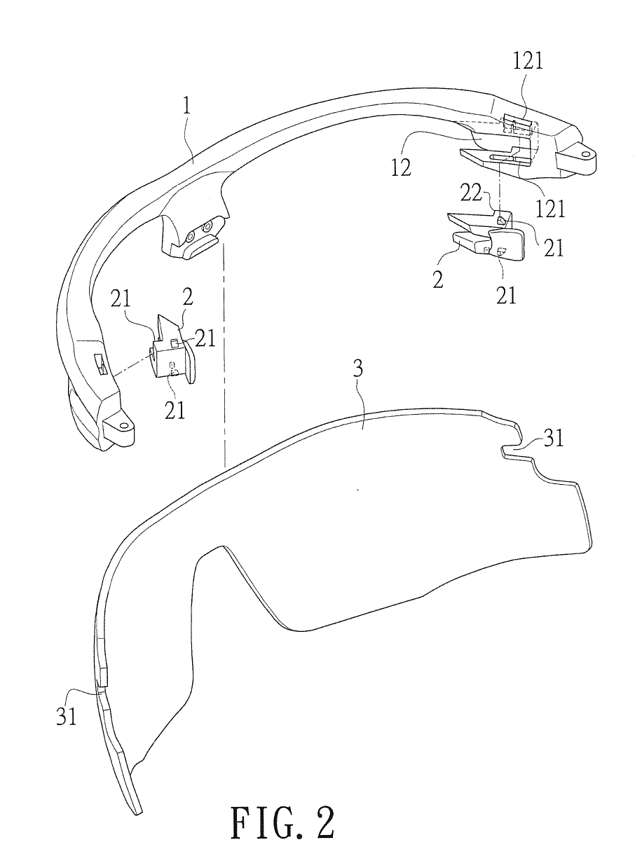

Please refer to FIG. 1 to FIG. 2, which are a front exploded view and a back exploded view of a lens and frame assembly structure according to an embodiment of the present invention, respectively. The lens and frame assembly structure comprises a frame 1, fastening elements 2, and a lens 3.

The frame 1 comprises a lens assembly slot 11, two sliding grooves 12 corresponded to the two sides of the lens assembly slot 11 respectively, and two long slots 121 formed on the top surface and bottom surface of each sliding groove 12 respectively.

The fastening elements 2 are set in the sliding grooves 12 of the frame 1 respectively, and each fastening element 2 comprises two retaining blocks 21 and an embedding part 22. The retaining blocks 21 are formed on the top surface and bottom surface of each fastening element 2 and corresponded to the long slots 121 on each sliding groove 12, thereby embedding the retaining blocks 21 into the long slots 121 to retaining the position of each fastening element 2 and allowing each fastening element 2 sliding in each sliding groove 12 without separation. The embedding part 22 projects out from each fastening element 2 toward the lens assembly slot 11 of the frame 1.

The lens 3 is assembled with the lens assembly slot 11 of the frame 1 and formed with two recesses 31 corresponded to the embedding part 22 of each fastening element 2 respectively.

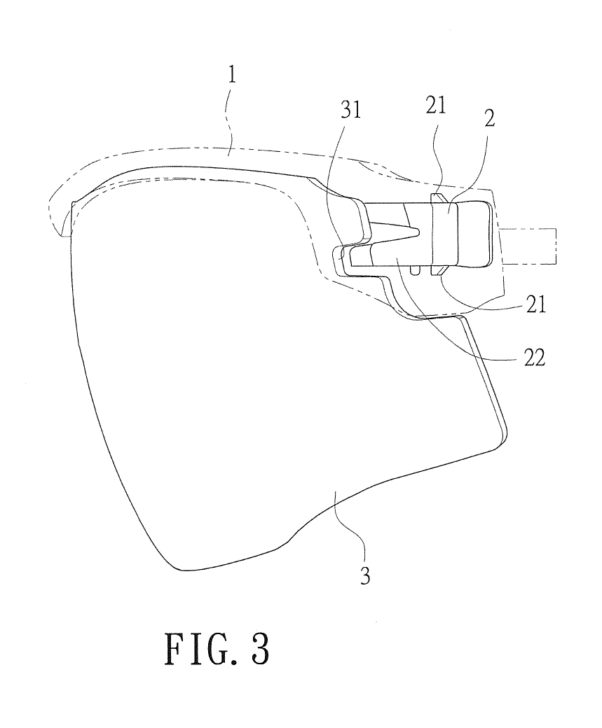

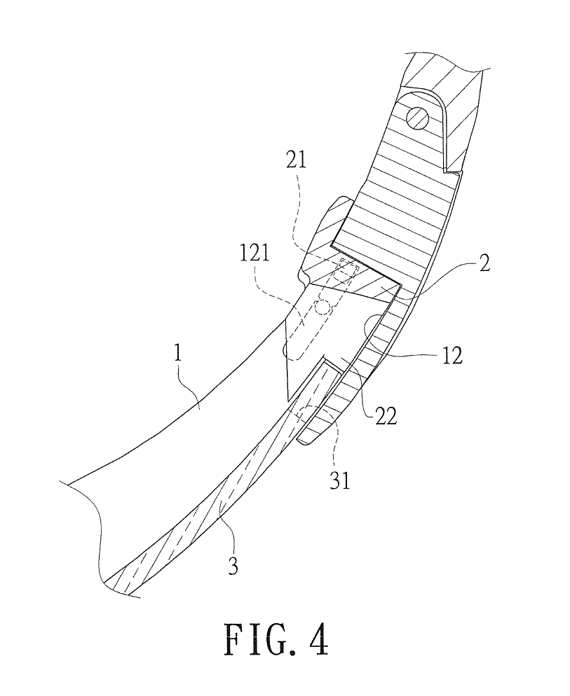

Please refer to FIG. 3 and FIG. 4, which are a side view and a top partial-sectional view of a lens and frame assembly structure for glasses during an assembly process according to an embodiment of the present invention, respectively. When the lens and frame assembly structure for glasses of the present invention is assembled, each fastening element 2 is set in each sliding groove 12, and the retaining blocks 21 on the top surface and bottom surface of each fastening element 2 are embedded into the long slots 121 which are formed on the top surface and bottom surface of each sliding groove 12 respectively, thereby embedding the retaining blocks 21 into the long slots 121 to retaining the position of each fastening element 2 and allowing each fastening element 2 sliding in each sliding groove 12 without separation. Then, the lens 3 is assembled with the lens assembly slot 11 of the frame 1.

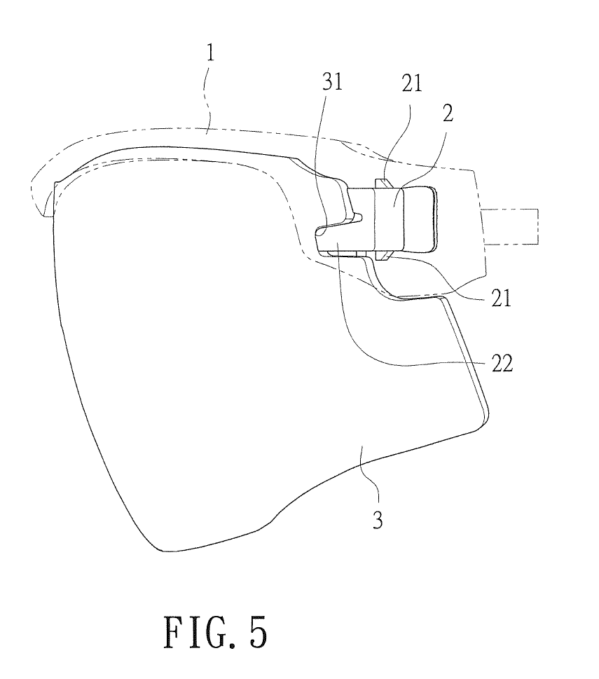

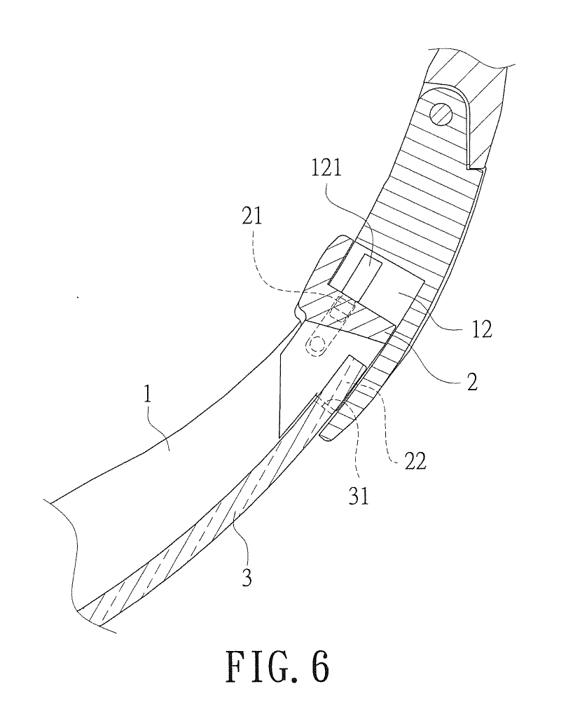

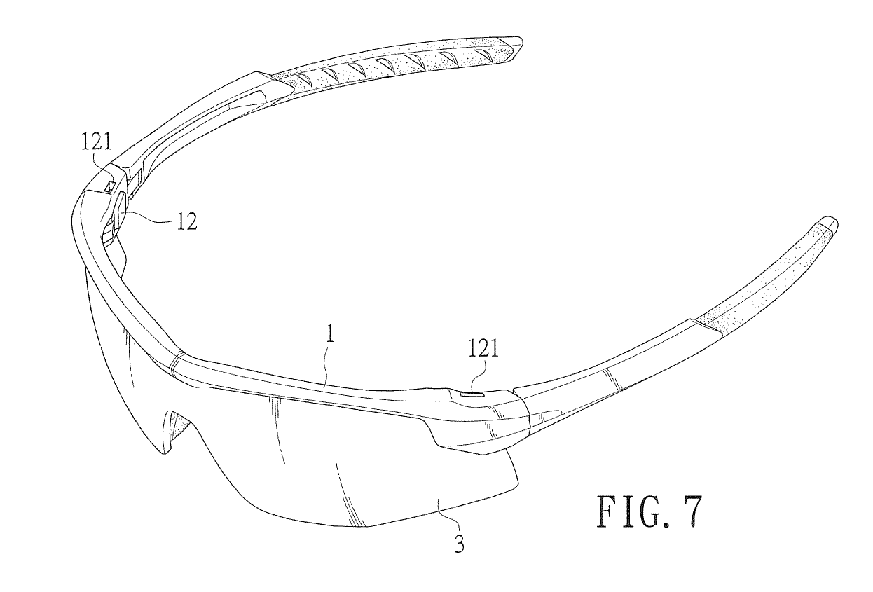

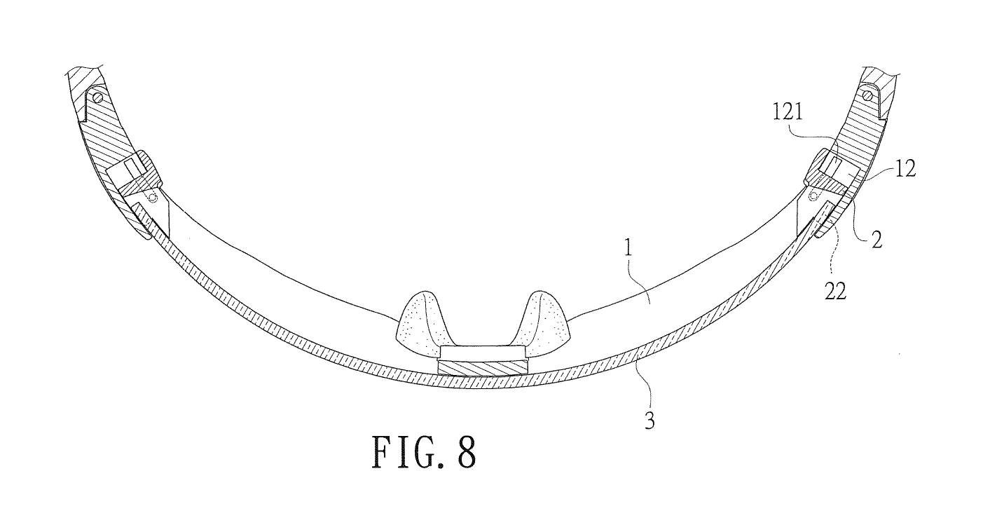

Please refer to FIG. 5 and FIG. 6, which are a side view and a top partial-sectional view of a lens and frame assembly structure for glasses when used according to an embodiment of the present invention, respectively. Each fastening element 2 is pushed toward the lens 3 to embed the embedding part 22 of each fastening element 2 into the recesses 31 of the lens 3; in the meantime, the lens 3 is fixed between the frame 1 and each fastening element 2, so that the lens 3 is certainly assembled with the frame 1 without separation. Please refer to FIG. 7 and FIG. 8, which are a three-dimensional view and a top sectional view of a lens and frame assembly structure for glasses according to an embodiment of the present invention, respectively. Moreover, when the lens 3 is disassembled with the frame 1, each fastening element 2 is pushed away the lens 3 to separate the embedding part 22 of each fastening element 2 and the recesses 31 of the lens 3, so it is convenient to disassemble the lens 3.

Therefore, the fastening elements on the frame are pushed to assemble or separate the lens and the frame without using any tools, so it is simpler and more convenient to assemble or separate the lens and the frame.

What is claimed is:

1. A lens and frame assembly structure for glasses, comprising:
a frame, comprising:
a lens assembly slot;
two sliding grooves, corresponded to the two side of the lens assembly slot respectively; and
two long slots formed on the top surface and bottom surface of each sliding groove respectively;
two fastening elements, set in the sliding grooves respectively, wherein each fastening element comprises:
two retaining blocks, formed on the top surface and bottom surface of each fastening element and corresponded to the long slots on the sliding grooves, thereby embedding the retaining blocks into the long slots on each sliding groove to retaining the position of each fastening element and allowing each fastening element sliding in each sliding groove without separation; and
an embedding part, projecting out from each fastening element toward the lens assembly slot; and
a lens, assembled with the lens assembly slot of the frame and formed with two recesses corresponded to the embedding part of each fastening element for embedding the embedding part into the recess.
